(19) United States
(12) Patent Application Publication
(10) Pub. No.: US 2005/0158065 A1
(43) Pub. Date: Jul. 21, 2005

(54) Data transfer control device and electronic equipment

(75) Inventor: Kuniaki Matsuda, Sapporo-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/989,363

(22) Filed: Nov. 17, 2004

(30) Foreign Application Priority Data
Nov. 18, 2003 (JP) 2003-388046

(51) Int. Cl. G03G 15/16

(52) U.S. Cl. 399/66

(57) ABSTRACT

Aspects of the invention can provide a data transfer control device that can switchover VBUS feed voltage. The transfer controller can send a switchover request packet to switch over a VBUS feed voltage to a plug B coupling side (device B side). When the transfer controller receives a switchover consent packet, it can instruct a feed switch circuit to switch over from normal voltage feed to low voltage feed. Then, monitor of the VBUS normal voltage level can be stopped and monitor of the VBUS low voltage level is started. The transfer controller receives the switchover request packet to switch over the VBUS feed voltage from the plug A coupling side (device A side). If it agrees to the switchover, it can send the switchover consent packet. And then, the monitor of the VBUS normal voltage level can be stopped and the monitor of the VBUS low voltage level is started. The switchover request packet and the switchover consent packet can be sent by a control transfer.

### BACKGROUND OF THE INVENTION

1. Field of Invention

Aspects of the invention can relate to a data transfer control device and electronic equipment.

2. Description of Related Art

Related art universal serial bus (USB) standard has attracted attention as an interface standard for connections between personal computers and electronic equipment (peripheral equipment). Such USB has a feature of having a power supply line so-called “VBUS line” besides a data line. In the USB standard, a side to which plug A is coupled has to feed power using the VBUS line. However, portable electronic equipment, such as cellular phones generally works on batteries. Consequently, considering the battery drain, it is preferred to reduce its power consumption as much as possible even when the side to which plug A is coupled feeds power of VBUS. See, for example, Japanese Unexamined Patent Publication No. 2002-344537.

### SUMMARY OF THE INVENTION

Aspects of the invention can provide a data transfer control device that can switchover VBUS feed voltage and electronic equipment.

Particularly, a first aspect of the invention relates to a data transfer control device for a data transfer through a Universal Serial Bus (USB). The data transfer control device of the first aspect of the invention can include a transfer controller controlling the data transfer and a feed switch circuit controlling a switch of a power supply to a VBUS line of the USB. When the data transfer control device is a data transfer control device coupled to a plug A of the USB, the transfer controller can send a switchover request packet to switch over a VBUS feed voltage from a normal voltage feed to a low voltage feed to a data transfer controller coupled to a plug B. Further, when the plug A coupling side data transfer control device receives a switchover consent packet from the plug B coupling side data transfer control device, it can instruct the feed switch circuit to switch over from the normal voltage feed to the low voltage feed.

In the first aspect of the invention, a request packet asking to switch over a VBUS voltage feed is sent to a plug B coupling side data control transfer device (transfer controller). Then, when a plug A coupling side data control transfer device receives a switchover consent packet to switch over the VBUS voltage feed, the feed switch circuit is instructed to switch over from a normal voltage feed to a low voltage feed. In this way, a negotiation to switch over the VBUS voltage feed from the normal voltage feed to the low voltage feed becomes possible. Therefore, when electronic equipment of the plug A coupling side works on battery, it can help to reduce the battery power consumption and it can improve the user's convenience. The plug A coupling side data control transfer device refers a data control transfer device that is included in electronic equipment coupled to the plug A, and the plug B coupling side data control transfer device refers a data control transfer device that is included in electronic equipment coupled to the plug B. The data control transfer device may perform a normal data transfer based on the USB standard or a data transfer based on so-called USB on-the-go (OTG).

In the data transfer control device, a normal voltage monitoring circuit monitoring a VBUS voltage level at the time of the VBUS normal voltage feed and a low voltage monitoring circuit monitoring the VBUS voltage level at the time of the VBUS low voltage feed may be included. And when the transfer controller instructs the feed switch circuit to switch over from the normal voltage feed to the low voltage feed, it may instruct the normal voltage monitoring circuit to stop monitoring the VBUS voltage level and instructs the low voltage monitoring circuit to start monitoring the VBUS voltage level. In this way, it cannot be happened that the device erroneously detects a normal state of the VBUS voltage level as an abnormal state because the monitor of the VBUS normal voltage level is stopped. Moreover, an abnormal state of the VBUS voltage level at the time of the low voltage feed can be properly detected because the monitor of the VBUS low voltage level is started.

In the data transfer control device, when a switchover from the low voltage feed to the normal voltage feed is instructed by an upper layer, the transfer controller may send a switchover notification packet to switch over the VBUS feed voltage from the low voltage feed to the normal voltage feed to the plug B coupling side data transfer control device and instructs the feed switch circuit to switch over from the low voltage feed to the normal voltage feed. In this way, when the upper layer such as an application program and a firmware that controls the data transfer control device gives the instruction, the VBUS normal voltage feed can be properly resumed.

In the data transfer control device, a normal voltage monitoring circuit monitoring a VBUS voltage level at the time of the VBUS normal voltage feed and a low voltage monitoring circuit monitoring the VBUS voltage level at the time of the VBUS low voltage feed may be included. And a wait process may be conducted after the transfer controller instructs the feed switch circuit to switch over from the low voltage feed to the normal voltage feed, and then the transfer controller may instruct the normal voltage monitoring circuit to start monitoring the VBUS voltage level. In this way, the monitor can be started after the VBUS voltage level is stabilized and it can be properly monitored whether the VBUS normal voltage feed is conducted appropriately or not.

In the data transfer control device, when the data transfer control device is the data transfer control device coupled to the plug A of the USB, the transfer controller may send a switch request packet to switch a VBUS power feed to the data transfer controller coupled to the plug B. Further, when the plug A coupling side data transfer control device receives a switch consent packet to switch the VBUS power feed from the plug B coupling side data transfer control device, it may instruct the feed switch circuit to halt the VBUS power feed.

In the data transfer control device of the first aspect of the invention, a request packet asking to switch a VBUS power feed is sent to the plug B coupling side data control transfer device (transfer controller). Then, when the plug A coupling side data control transfer device receives a switch consent packet to switch over the VBUS power feed from the plug B coupling side data control transfer device, the VBUS power feed by the switch circuit of the plug A coupling side is halted. In this way, the VBUS power feed can be switched from the plug A coupling side to the plug B coupling side by negotiation. Therefore, when the plug A coupling side electronic equipment works on battery and the plug B coupling side electronic equipment works on AC power source, it can help to reduce the battery power consumption and it can improve the user's convenience. Moreover, when both the plug A coupling side and the plug B coupling side work on battery, the both batteries can be efficiently used by combining the VBUS power feed switch and the VBUS feed voltage switchover.

In the data transfer control device, the transfer controller may send the switchover request packet by control transfer of the USB. Furthermore, the switchover request may be sent by other transfer method than the control transfer.

A second aspect of the invention can relate to a data transfer control device for a data transfer through a Universal Serial Bus (USB). The data transfer control device of the second aspect of the invention can include a transfer controller controlling the data transfer and a feed switch circuit controlling a switch of a power supply to a VBUS line of the USB. When the data transfer control device is a data transfer control device coupled to a plug B of the USB, the transfer controller receives a switchover request packet to switch over a VBUS feed voltage from a normal voltage feed to a low voltage feed from a data transfer controller coupled to a plug A, and when the plug B coupling side data transfer control device agrees to the switchover, the transfer controller sends a switchover consent packet to switch over from the normal voltage feed to the low voltage feed to the plug A coupling side data transfer control device.

In the second aspect of the invention, a plug B coupling side data control transfer device (transfer controller) receives a request packet asking to switch over a VBUS voltage feed from a plug A coupling side data control transfer device (transfer controller). Then, when the plug B coupling side data control transfer device agrees to the switchover, a switchover consent packet to switch over the VBUS voltage feed is sent to the plug A coupling side data control transfer device (transfer controller). In this way, a negotiation to switch over the VBUS voltage feed from the normal voltage feed to the low voltage feed becomes possible. Therefore, when electronic equipment of the plug A coupling side works on battery, it can help to reduce the battery power consumption and it can improve the user's convenience.

In the data transfer control device, a normal voltage monitoring circuit monitoring a VBUS voltage level at the time of the VBUS normal voltage feed and a low voltage monitoring circuit monitoring the VBUS voltage level at the time of the VBUS low voltage feed may be included. And when the transfer controller sends the switchover consent packet to switch over from the normal voltage feed to the low voltage feed to the plug A coupling side data transfer control device, it may instruct the normal voltage monitoring circuit to stop monitoring the VBUS voltage level and instructs the low voltage monitoring circuit to start monitoring the VBUS voltage level. In this way, it cannot be happened that the device erroneously detects a normal state of the VBUS voltage level as an abnormal state because the monitor of the VBUS normal voltage level is stopped. Moreover, an abnormal state of the VBUS voltage level at the time of the low voltage feed can be properly detected because the monitor of the VBUS low voltage level is started.

In the data transfer control device, a normal voltage monitoring circuit monitoring a VBUS voltage level at the time of the VBUS normal voltage feed and a low voltage monitoring circuit monitoring the VBUS voltage level at the time of the VBUS low voltage feed may be included. And when the transfer controller receives the switchover consent packet to switch over the VBUS feed voltage from the low voltage feed to the normal voltage feed from the plug A coupling side data transfer control device, a wait process may conducted, and then the transfer controller may instruct the normal voltage monitoring circuit to start monitoring the VBUS voltage level. In this way, the monitor can be started after the VBUS voltage level is stabilized and it can be properly monitored whether the VBUS normal voltage feed is conducted appropriately or not.

In the data transfer control device, when the data transfer control device is the data transfer control device coupled to the plug B of the USB, the transfer controller may receive a switch request packet to switch a VBUS power feed from the data transfer controller coupled to the plug A, and when the plug B coupling side data transfer control device agrees to the switch, the transfer controller may send a switch consent packet to switch the VBUS power feed to the plug A coupling side data transfer control device and instruct the feed switch circuit to start the VBUS power feed.

In the data transfer control device of the second aspect of the present invention, a switch request packet asking to switch a VBUS power feed is received from the plug A coupling side data control transfer device (transfer controller). Then, when a plug B coupling side data control transfer device (transfer controller) agrees to the switch, a switch consent packet to switch over the VBUS power feed is sent to the plug A coupling side data control transfer device (transfer controller). Then, the VBUS power feed by the switch circuit of the plug B coupling side is started. In this way, the VBUS power feed can be switched from the plug A coupling side to the plug B coupling side by negotiation. Therefore, when the plug A coupling side electronic equipment works on battery and the plug B coupling side electronic equipment works on AC power source, it can help to reduce the battery power consumption and it can improve the user's convenience.

In the data transfer control device, the transfer controller may send the switchover consent packet by control transfer of the USB. Furthermore, the switchover consent may be sent by other transfer method than the control transfer.

The invention can also relate to an electronic equipment that includes the above-described data transfer control device and a central processing unit (CPU) controlling the data transfer control device.

### BRIEF DESCRIPTION OF THE DRAWINGS

The invention will be described with reference to the accompanying drawings, wherein like numerals reference like elements, and wherein:

FIGS. 1A through C are explanation drawings of a plug A and a plug B of USB;

FIGS. 2A through C are illustrations of a VBUS feed voltage switchover technique and a VBUS power feed switch technique of an exemplary embodiment;

FIG. 3 shows a configuration example of a data transfer control device of an exemplary embodiment;

FIG. 4 is an exemplary action flow of a plug A coupling side data transfer control device;

FIG. 5 is an exemplary action flow of the plug A coupling side data transfer control device;

FIG. 6 is an exemplary action flow of a plug B coupling side data transfer control device;

FIG. 7 is an exemplary action flow of the plug B coupling side data transfer control device;

FIG. 8 is an exemplary action flow of the plug A coupling side data transfer control device;

FIG. 9 is an exemplary action flow of the plug A coupling side data transfer control device;

FIG. 10 is an exemplary action flow of the plug B coupling side data transfer control device;

FIG. 11 is an exemplary action flow of the plug B coupling side data transfer control device;

FIG. 12 is a state transition diagram of the plug A coupling side data transfer control device;

FIG. 13 is a state transition diagram of the plug B coupling side data transfer control device;

FIG. 14 is an exemplary drawing of a control transfer of USB; and

FIG. 15 shows an exemplary configuration example of electronic equipment.

### DETAILED DESCRIPTION OF PREFERRED EMBODIMENTS

Exemplary embodiments of the invention will now be described in detail. It should be understood that the exemplary embodiments described below shall not limit nature of the invention which is described in claims. Also, all of components described in the embodiments below are not necessarily essential as a solution for the invention.

1. Plug A and Plug B

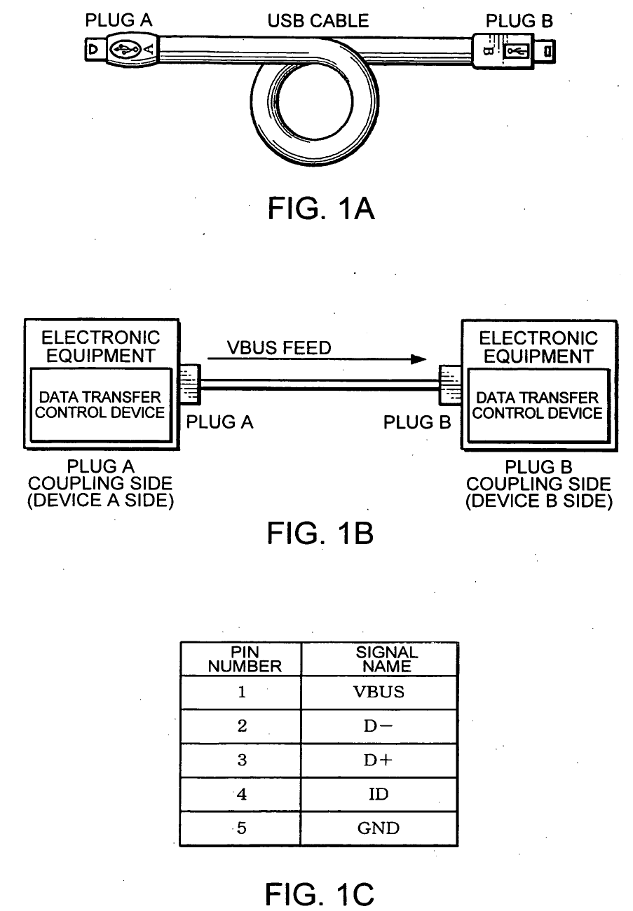

In the USB, as shown in FIG. 1A, a plug A and a plug B (a first plug and a second plug) are defined as connector standard. A receptacle A that has a structure in which the plug A can be inserted and a receptacle B that has a structure in which the plug B can be inserted are also defined. In addition, a mini-plug A, a mini-plug B, a mini-receptacle A and a mini-receptacle B are defined in order to reduce the size of the connector. Furthermore, in USB On-The-Go (OTG) which enables a peripheral (USB device) to have a simplified host function, a mini-receptacle AB in which both the plug A and the plug B can be inserted is defined.

In USB, a side to which the plug A (mini-plug A) is coupled feeds power to a side to which the plug B (mini-plug B) is coupled through VBUS. Accordingly, in FIG. 1B, an electronic equipment (data control transfer device) to which the plug A is coupled supplies VBUS power to an electronic equipment (data control transfer device) to which the plug B is coupled.

In normal USB, the plug A is coupled to a host (USB host) and the plug B is coupled to the USB device (peripheral). On the other hand, in OTG, the plug A coupling side is called a device A and the plug B coupling side is called a device B. In default state, the device A becomes the host and the device B becomes the peripheral (USB device). However, roles of the host and the peripheral can be switched with Host Negotiation Protocol (HNP). This means that the device A to which the plug A is coupled can be the peripheral and the device B to which the plug B is coupled can be the host and so-called dual-role device can be realized.

In OTG, in order to distinguish a type of a plug inserted in the mini-receptacle AB, an ID terminal is defined in addition to VBUS, D +/− and GND terminals, as shown in FIG. 1C. The ID terminal in the mini-plug A is coupled to GND, and the ID terminal in the mini-plug B is open. Therefore, it can be determined that either the mini-plug A or the mini-plug B is inserted to the mini-receptacle AB by using this ID terminal.

2. Negotiation to Feed VBUS Low Voltage

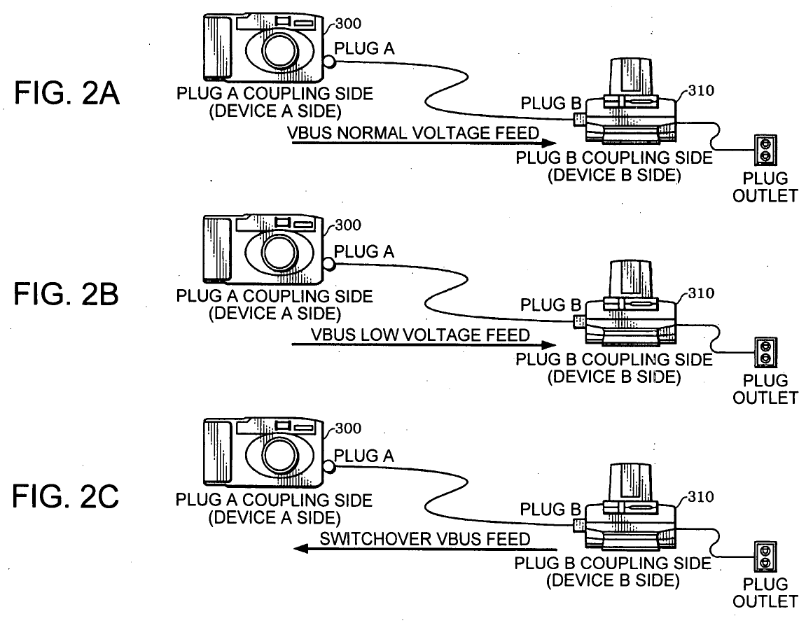

As described above, the side to which the plug A is coupled has to feed VBUS power to the side to which the plug B is coupled in the USB standard. For example, as shown in FIG. 2A, a digital camera 300, which is portable electronic equipment, usually has the receptacle A (mini-receptacle A or mini-receptacle AB) of USB to which the plug A of a USB cable is coupled. On the other hand, a printer 310, which is electronic equipment, usually has the receptacle B of USB to which the plug B of the USB cable is coupled. In this case, the digital camera 300 that is the plug A coupling side (the device A side) has to feed VBUS power (supply power to the VBUS line) to the printer 310 that is the plug B coupling side (the device B side).

However, the digital camera 300 generally works on battery and the battery runs down quickly when the digital camera 300 feeds VBUS power. Therefore, it is preferred to reduce its power consumption as much as possible even when the plug A coupling side feeds the VBUS power.

For this reason, the invention adopts a technique to switch from a normal voltage feed (for example, feed 5 V of power source) to a low voltage feed (for example, feed 3 V of power source) by negotiation. In other words, when an application program or a firmware instructs a negotiation on switchover of the VBUS feed voltage, the negotiation for deciding whether the low voltage feed should be conducted or not is started. And when it is decided to conduct the low voltage feed by the negotiation, for example, the plug A coupling side feeds the VBUS low voltage. With this technique, the digital camera 300 feeds VBUS power not with the normal voltage but with the low voltage. Consequently, the battery drain of the digital camera 300 can be reduced.

3. Structure

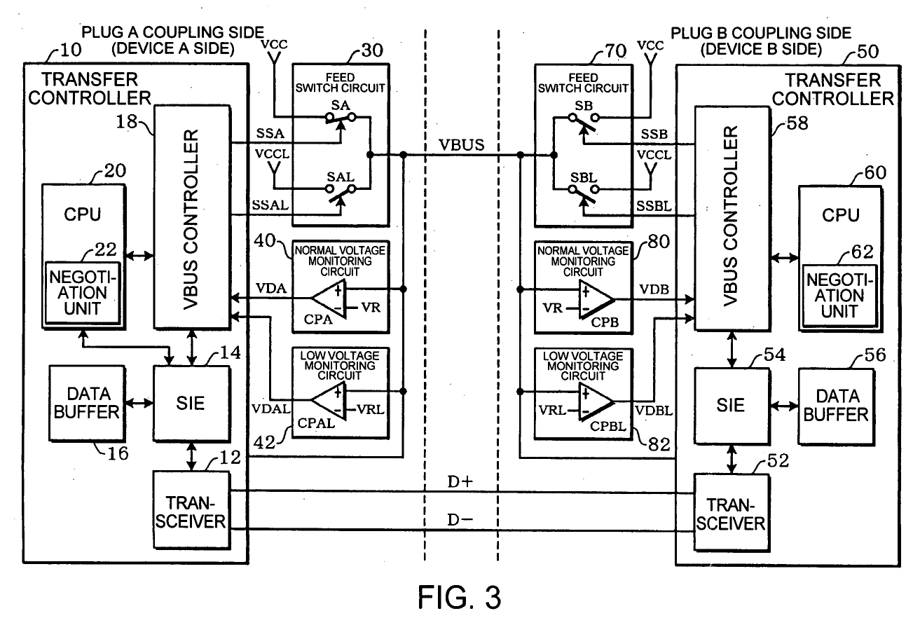

A configuration example of the data transfer control device that can realize the technique of the embodiment is shown in FIG. 3. A plug A coupling side (device A side) data transfer control device (a data transfer control device included in the electronic equipment coupled to the plug A) can include a transfer controller 10, a feed switch circuit 30, a normal voltage monitoring circuit 40 and a low voltage monitoring circuit 42. The transfer controller 10 is a controller for data transfer through USB and includes a transceiver 12, a serial interface engine (SIE) 14, a data buffer 16, a VBUS controller 18 and central processing unit (CPU) 20. A part of these functions (circuits) may be omitted.

The transceiver 12 is a circuit that sends and receives USB data by using differential data signals D+ and D−. The transceiver 12 includes a physical layer circuit of USB. More particularly, the transceiver 12 produces a line state of D+ and D− (J, K, SE0 and so on) and performs parallel-serial conversion, serial-parallel conversion, bit stuffing, bit unstuffing, Non-Return to Zero Inverted (NRZI) decoding, NRZI encoding and the like.

The SIE 14 is a circuit to execute all kinds of processes for USB's transferring packets. This SIE 14 may include a packet handler circuit, a suspend & resume control circuit, a transaction manage circuit (all unshown in the figure) and the like.

The data buffer 16 is a buffer (first in, first out) for temporally storing (buffering) data (transmit data or receive data) transferred through USB. Such data buffer 16 may consist of memories, such as a random access memory (RAM).

The VBUS controller 18 is a controller for the VBUS power feed and monitoring the VBUS voltage level. More particularly, the VBUS controller 18 controls the VBUS power feed at the feed switch circuit 30 and the monitoring of the VBUS voltage level at the normal voltage monitoring circuit 40 and the low voltage monitoring circuit 42.

The CPU 20 controls each circuit block in the transfer controller 10 and performs software processes for the data transfer control. The CPU 20 includes a negotiation unit 22 that performs a negotiation process for switchover the VBUS feed voltage and switching the VBUS power feed. Functions of the negotiation unit 22 may be realized with hardware, such as CPU (processor), and software, such as the firmware and the application program.

The feed switch circuit 30 is a circuit that controls a switch of the power supply to the VBUS line. More particularly, the feed switch circuit 30 includes switch elements SA and SAL that consist of transistors and the like. When a switch signal SSA from the VBUS controller 18 becomes active, the switch element SA is turned ON and a normal voltage source VCC that supplies, for example, 5 V is coupled to the VBUS line. It starts a VBUS normal voltage feed by the VCC. When a switch signal SSAL from the VBUS controller 18 becomes active, the switch element SAL is turned ON and a low voltage source VCCL that supplies, for example, 3 V is coupled to the VBUS line. It starts a VBUS low voltage feed by the VCCL. In contrast, when the switch signals SSA and SSAL become inactive, the switch elements SA and SAL are turned OFF and the connections between the voltage sources VCC and VCCL and the VBUS line are broken. It stops the VBUS power feed. The voltage sources VCC and VCCL may be supplied by battery (rechargeable battery) or alternating-current (AC) power.

The normal voltage monitoring circuit 40 is a circuit that monitors the VBUS voltage level at the time of the VBUS normal voltage feed (monitors whether it is active voltage level or not when the normal voltage is fed). More particularly, the normal voltage monitoring circuit 40 includes a comparator CPA. This comparator CPA compares the VBUS voltage level with a reference voltage level VR (active voltage level at the time of the normal voltage feed, for example, 4.4 V). When the VBUS voltage level becomes lower than the reference voltage level VR, the comparator CPA activates a detection signal VDA.

In the USB (OTG), in the case of a low-powered device whose current supply capacity is low, the VBUS voltage level has to be maintained within a range of 4.4-5.25 V. In the case of a high-powered device whose current supply capacity is high, the VBUS voltage level has to be maintained within a range of 4.75-5.25 V. Therefore, it is abnormal that the VBUS voltage level becomes below 4.4 V (the active voltage level) in both cases. The normal voltage monitoring circuit 40 monitors the VBUS voltage level, and detects such abnormal state and activates the detection signal VDA.

The low voltage monitoring circuit 42 is a circuit that monitors the VBUS voltage level at the time of the VBUS low voltage feed (monitors whether it is active voltage level or not when the low voltage is fed). More particularly, the low voltage monitoring circuit 42 includes a comparator CPAL. This comparator CPAL compares the VBUS voltage level with a reference voltage level VRL (active voltage level at the time of the low voltage feed, for example, 2.85 V). When the VBUS voltage level becomes lower than the reference voltage level VRL, the comparator CPAL activates a detection signal VDAL.

The data transfer control device (data transfer control device which is included in the electronic equipment coupled to the plug B) of the plug B coupling side (device B side) includes a transfer controller 50, a feed switch circuit 70, a normal voltage monitoring circuit 80 and a low voltage monitoring circuit 82. The transfer controller 50 includes a transceiver 52, a serial interface engine (SIE) 54, a data buffer 56, a VBUS controller 58 and a CPU 60. A part of these functions (circuits) may be omitted. These structures and operations of the transfer controller 50, the transceiver 52, the SIE 54, the data buffer 56, the VBUS controller 58, the CPU 60, the feed switch circuit 70, the normal voltage monitoring circuit 80 and the low voltage monitoring circuit 82 and the like in the plug B coupling side are substantially the same as respective those of the transfer controller 10, the transceiver 12, the SIE 14, the data buffer 16, the VBUS controller 18, the CPU 20, the feed switch circuit 30, the normal voltage monitoring circuit 40 and the low voltage monitoring circuit 42 except the negotiation processes. Therefore, these explanations are omitted here.

When the data transfer control device of the plug A coupling side or the plug B coupling side is conformed to the OTG standard of USB, the data transfer control device should include a state controller that controls a plurality of states including a host operation state in which the controller plays a host role and a peripheral operation state in which the controller plays a peripheral role. The data transfer control device should also include a host controller that transfers data as a host at the time of the host operation and a peripheral controller that transfers data as a peripheral at the time of the peripheral operation.

4. Actions at the Time of VBUS Feed Voltage Switchover

Next, actions of the data transfer control device of the invention when the VBUS feed voltage is switched over are schematically described. In this exemplary embodiment, the transfer controller 10 of the plug A coupling side (device A side) sends a switchover request packet to switch over from normal voltage feed to low voltage feed to the data transfer control device (transfer controller 50) of the plug B coupling side (device B side) at the time of the VBUS feed voltage switchover. Then, when the transfer controller 10 receives a switchover consent packet to switch over to the low voltage feed from the data transfer control device (transfer controller 50) of the plug B coupling side, it instructs the feed switch circuit 30 to switch over from the normal voltage feed to the low voltage feed.

More particularly, the transceiver 12, the SIE 14 and others in the transfer controller 10 transmit the switchover request packet and receive the switchover consent packet by, for example, control transfer of USB. Then, when the switchover consent packet is received, the VBUS controller 18 inactivates the switch signal SSA and turns off the switch element SA. At the same time, the VBUS controller 18 activates the switch signal SSAL and turns on the switch element SAL. By these actions, the VBUS feed voltage changes from the normal feed voltage (for example, 5 V) to the low feed voltage (for example, 3 V). These series of negotiation processes are performed under the control of the negotiation unit 22.

On the other hand, the transfer controller 50 of the plug B coupling side receives the switchover request packet to switch over to the low voltage feed from the data transfer control device (transfer controller 10) of the plug A coupling side. When the transfer controller 50 agrees to the switchover to the low voltage feed, it sends the switchover consent packet to switch over to the low voltage feed to the data transfer control device (transfer controller 10) of the plug A coupling side.

More particularly, the transceiver 52, the SIE 54 and others in the transfer controller 50 receive the switchover request packet by, for example, control transfer of USB. Then, when the transfer controller agrees to the switchover, the transceiver 52, the SIE 54 and others send the switchover consent packet by, for example, control transfer of USB. These series of negotiation processes are performed under the control of the negotiation unit 62.

As described above, in this exemplary embodiment, the VBUS feed voltage is successfully switched over from the normal voltage feed to the low voltage feed. Consequently, for example, the digital camera 300 that is coupled to the plug A is able to feed VBUS power in low voltage to the printer 310 that is coupled to the plug B, as shown in FIG. 2B. Therefore, when the digital camera 300 works on a battery, the battery is drained in low voltage and it leads to reduce the battery power consumption. In addition, in this exemplary embodiment, such VBUS feed voltage switchover is conducted through the negotiation process using the packet transfer. Therefore, the VBUS feed voltage switchover is reliably and safely conducted because the VBUS feed voltage can be switched over as electronic equipment confirms each other whether the other electronic equipment can work on the low voltage VBUS feed or not. Furthermore, there is an advantage that the VBUS feed voltage switchover can be realized by only mounting firmware or application program for the switchover on the data transfer control device. The VBUS feed voltage switchover request and the switchover consent can be told by other means (for example, change in the voltage level of the data line) than the packet transfer.

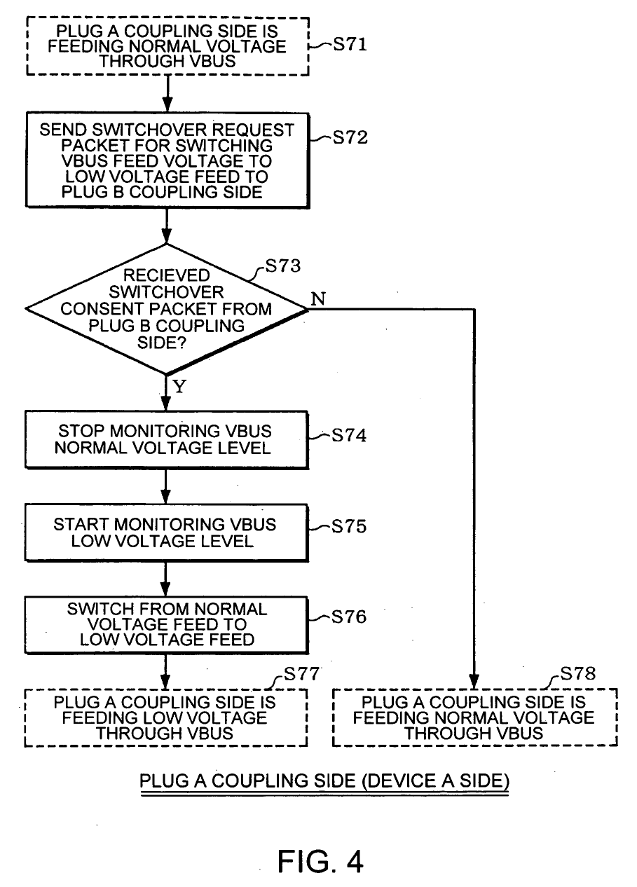

Next, the actions of the data transfer control device of the present exemplary embodiment when the VBUS feed voltage is switched over are described in detail with reference to flowcharts in FIGS. 4 through 7.

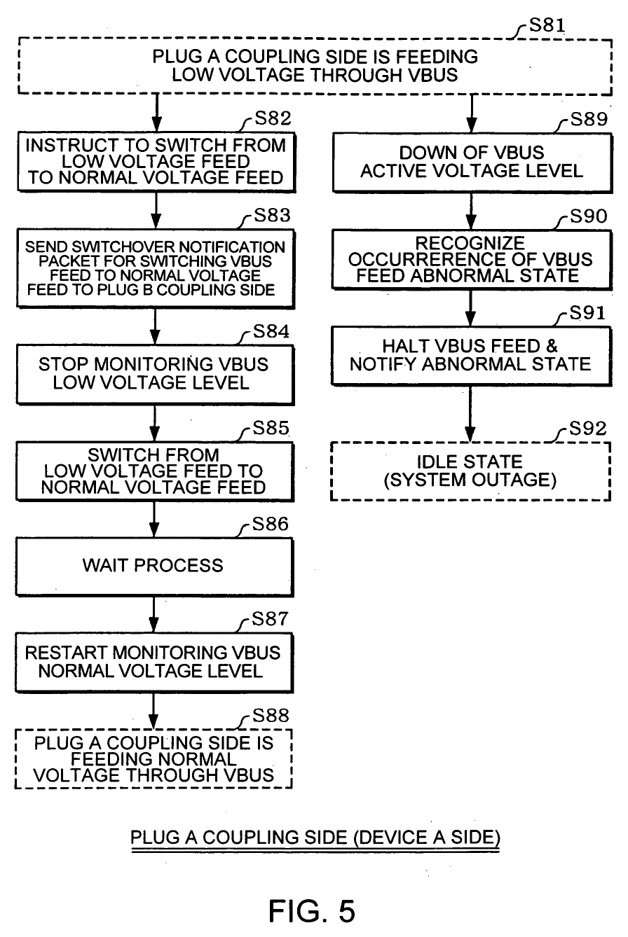

FIGS. 4 and 5 show an exemplary action flow of the data transfer control device of the plug A coupling side. Firstly, the switchover request packet to switch the VBUS feed voltage to a low voltage feed is sent to the plug B coupling side (step: S72) while the plug A coupling side is feeding a normal voltage through the VBUS (step: S71). When the plug A coupling side receives the switchover consent packet from the plug B coupling side (step: S73), monitor of the VBUS normal voltage level (monitors the active voltage level at the time of the normal voltage feed) is stopped (step: S74). In other words, the normal voltage monitoring circuit 40 is instructed to stop monitoring the VBUS voltage level. Then, monitor of the VBUS low voltage level (monitors the active voltage level at the time of the low voltage feed) is started (step: S75). In other words, the low voltage monitoring circuit 42 is instructed to start monitoring the VBUS voltage level.

Then, the VBUS power feed is switched over from the normal voltage feed to the low voltage feed (step: S76). In other words, the feed switch circuit 30 is instructed to stop the normal voltage feed (turns off the switch element SA) and to start the low voltage feed (turns on the switch element SAL). In this way, the plug A coupling side gets to feed the low voltage through the VBUS (step: S77).

On the other hand, when the plug A coupling side does not receives the switchover consent packet (receives a switchover denial packet) from the plug B coupling side (step: S73), the VBUS feed voltage switchover is not happened and the plug A coupling side keeps feeding the normal voltage through the VBUS (step: S78).

As shown in FIG. 4, in this exemplary embodiment, when the VBUS power feed is switched over to the low voltage feed, the monitor of the VBUS normal voltage level (monitors the active voltage level at the time of the normal voltage feed) is stopped and the monitor of the VBUS low voltage level (monitors the active voltage level at the time of the low voltage feed) is started (step: S74, S75 and S76).

As described above, it cannot happen that the device erroneously detects a normal state of the VBUS voltage level as an abnormal state because the monitor of the VBUS normal voltage level is stopped when the VBUS power feed is switched over to the low voltage feed. Moreover, an abnormal state of the VBUS voltage level at the time of the low voltage feed can be properly detected because the monitor of the VBUS low voltage level is started when the VBUS power feed is switched over to the low voltage feed. In this way, this exemplary embodiment realizes the switchover of the VBUS feed voltage, as well as it meets requirements of the USB standard on the monitor of the VBUS voltage level.

Next, an exemplary action flow in the FIG. 5 is explained. Firstly, the plug A coupling side is feeding the normal voltage through the VBUS (step: S81). When the switchover from the normal voltage feed to the low voltage feed is instructed by an upper layer (for example, application layer and the like) (step: S82), a switchover notification packet to switch over the VBUS voltage feed to the normal voltage feed is sent to the plug B coupling side (step: S83). Then, the monitor of the VBUS low voltage level is stopped (step: S84). In other words, the low voltage monitoring circuit 42 is instructed to stop monitoring the VBUS voltage level.

Then, the VBUS power feed is switched over from the low voltage feed to the normal voltage feed (step: S85). In other words, the feed switch circuit 30 is instructed to stop the low voltage feed (turns off the switch element SAL) and to start the normal voltage feed (turns on the switch element SA). Subsequently, in order to wait the VBUS voltage level to be stabilized, the process is waited (step: S86). After that, the monitor of the VBUS normal voltage level is resumed (started) (step: S87). In other words, the normal voltage monitoring circuit 40 is instructed to resume monitoring the VBUS voltage level. In this way, the plug A coupling side gets to feed the normal voltage through the VBUS (step: S88).

If the VBUS active voltage level goes down (step: S89) while the plug A coupling side is feeding the normal voltage through the VBUS (step: S81), it is recognized that a VBUS feed abnormal state is occurred (step: S90). Subsequently, the VBUS feed is halted while the occurrence of the abnormal state is notified to the upper layer and the like (step: S91). Then, the device becomes idle state in which the functions of the device are stopped (step: S92).

In this exemplary embodiment, when the switchover from the low voltage feed to the normal voltage feed is instructed by the upper layer, such as the application layer, the switchover notification packet to switch over the VBUS voltage feed to the normal voltage feed is sent to the plug B coupling side (step: S82 and S83). Then, the VBUS power feed is switched over from the low voltage feed to the normal voltage feed (step: S85).

In this way, it is possible to get back to the normal voltage feed from the low voltage feed when the application program or the firmware indicates the switchover to the normal voltage feed. Such switchover is told to the plug B coupling side by the switchover notification packet. Therefore, it is possible to switch over the VBUS feed voltage reliably and safely from the low voltage feed to the normal voltage feed.

In this exemplary embodiment, after the switchover from low voltage feed to the normal voltage feed is conducted, the wait process is conducted. Then, the monitor of the VBUS normal voltage level is resumed (started) (step: S85, S86 and S87).

In this way, the monitor of the VBUS normal voltage level can be started after the VBUS voltage level is stabilized because the monitor is resumed after the wait process. Therefore, it can be properly monitored whether the plug A coupling side feeds the VBUS normal voltage appropriately or not.

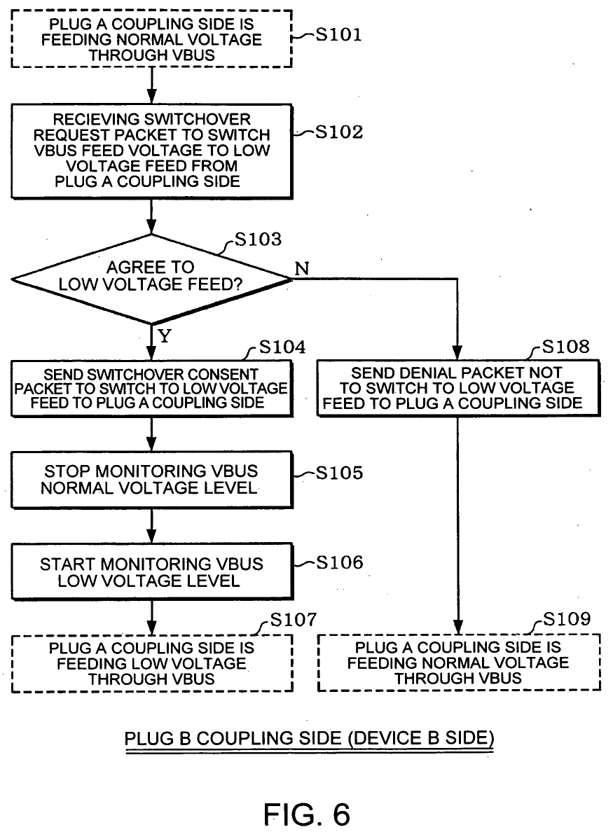

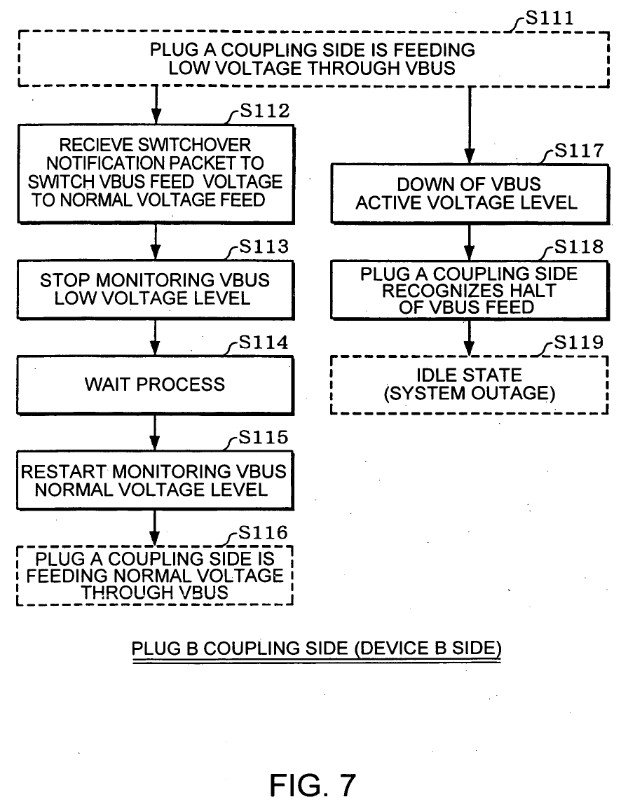

FIGS. 6 and 7 show exemplary action flows of the data transfer control device of the plug B coupling side. Firstly, the plug B coupling side receives the switchover request packet to switch the VBUS feed voltage to the low voltage feed from the plug A coupling side (step: S102) while the plug A coupling side is feeding the normal voltage through the VBUS (step: S101). When the plug B coupling side agrees to the switchover of the VBUS feed voltage (step: S103), the switchover consent packet is sent to the plug A coupling side (step: S104).

Then, the monitor of the VBUS normal voltage level is stopped (step: S105). In other words, the normal voltage monitoring circuit 80 is instructed to stop monitoring the VBUS voltage level. Then, the monitor of the VBUS low voltage level is started (step: S106). In other words, the low voltage monitoring circuit 82 is instructed to start monitoring the VBUS voltage level. In this way, the plug A coupling side gets to feed the low voltage through the VBUS (step: S107).

On the other hand, when the plug B side does not agree to switch over the VBUS feed voltage (step: S103), the switchover denial packet telling not to switch over to the low voltage feed is sent to the plug A coupling side (step: S108). With this action, the VBUS feed voltage switchover is not happened and the plug A coupling side keeps feeding the normal voltage through the VBUS (step: S109).

As shown in FIG. 6, in this exemplary embodiment, when the switchover consent packet to switch over to the low voltage feed is sent to the plug A coupling side, the monitor of the VBUS normal voltage level is stopped and the monitor of the VBUS low voltage level is started (step: S104, S105 and S106).

In the above-described way, it cannot be happened that the device erroneously detects the normal state of the VBUS voltage level as the abnormal state because the monitor of the VBUS normal voltage level is stopped when the switchover consent packet to switchover to the low voltage feed is sent. Moreover, the abnormal state of the VBUS voltage level at the time of the low voltage feed can be properly detected because the monitor of the VBUS low voltage level is started when the switchover consent packet to switchover to the low voltage feed is sent.

Next, an action flow in the FIG. 7 is explained. Firstly, the plug A coupling side is feeding the low voltage through the VBUS (step: S111). When the switchover notification packet to switch over the VBUS voltage feed to the normal voltage feed is received (step: S 112), the monitor of the VBUS low voltage level is stopped (step: S 113). In other words, the low voltage monitoring circuit 82 is instructed to stop monitoring the VBUS voltage level. Subsequently, in order to wait the VBUS voltage level to be stabilized, the process is waited (step: S114). After that, the monitor of the VBUS normal voltage level is resumed (started) (step: S 115). In other words, the normal voltage monitoring circuit 80 is instructed to resume monitoring the VBUS voltage level. In this way, the plug A coupling side gets to feed the normal voltage through the VBUS (step: S116).

If the VBUS active voltage level goes down (step: S117) while the plug A coupling side is feeding the normal voltage through the VBUS (step: S111), it is recognized that the plug A coupling side halted the VBUS power feed (step: S118). In this case, the device becomes idle state in which the functions of the device are stopped (step: S119).

In this embodiment, when the switchover notification packet telling to switch over from the low voltage feed to the normal voltage feed is received, the wait process is conducted. Then, the monitor of the VBUS normal voltage level is resumed (started) (step: S112, S113 and S114). In this way, the monitor of the VBUS normal voltage level can be started after the VBUS voltage level is stabilized because the monitor is resumed after the wait process. Therefore, it can be properly monitored whether the plug A coupling side feeds the VBUS normal voltage appropriately or not.

5. Negotiation to Switch VBUS Power Feed

In the USB standard, the side to which the plug A is coupled has to feed VBUS power to the side to which the plug B is coupled. For example, as shown in FIG. 2A, the digital camera 300, which is the portable electronic equipment, usually has the receptacle A (mini-receptacle A or mini-receptacle AB) of USB to which the plug A of the USB cable is coupled. On the other hand, the printer 310, which is the electronic equipment, usually has the receptacle B of USB to which the plug B of the USB cable is coupled. In this case, the digital camera 300 that is the plug A coupling side (the device A side) has to feed the VBUS power (supply power to the VBUS line) to the printer 310 that is the plug B coupling side (the device B side).

However, the digital camera 300 generally works on battery and the battery runs down quickly when the digital camera 300 feeds VBUS power. It would be inconvenient for the user. On the other hand, it is not much problem for the printer 310 to feed the VBUS power because the printer 310 has the AC power source.

Considering this, the invention can adopt a technique to switch a VBUS feeder by negotiation. In this way, the printer 310 having the AC power source can feed the VBUS power to the digital camera 300 as shown FIG. 2C. Consequently, the battery drain of the digital camera 300 can be reduced.

6. Actions at the time of VBUS power feed switch

Next, actions of the data transfer control device of the exemplary embodiment when the VBUS power feed is switched are schematically described. In this embodiment, when the VBUS power feed is switched, the transfer controller 10 of the plug A coupling side (device A side) sends a switch request packet to switch the VBUS power feed to the data transfer control device (transfer controller 50) of the plug B coupling side (device B side). Then, when the transfer controller 10 receives the switch consent packet to switch the VBUS power feed from the data transfer control device (transfer controller 50) of the plug B coupling side, it instructs the feed switch circuit 30 to halt the VBUS power feed.

More particularly, the transceiver 12, the SIE 14 and others in the transfer controller 10 transmit the switch request packet and receive the switch consent packet by, for example, the control transfer of USB. Then, when the switch consent packet is received, the VBUS controller 18 deactivates the switch signals SSA and SSAL and turns off the switch elements SA and SAL. By these actions, the VBUS power feed by the plug A coupling side is stopped. These series of negotiation processes are performed under the control of the negotiation unit 22.

On the other hand, the transfer controller 50 of the plug B coupling side receives the switch request packet to switch the VBUS power feed from the data transfer control device (transfer controller 10) of the plug A coupling side. When the transfer controller 50 agrees to the VBUS power feed switch, it sends the switch consent packet to the data transfer control device (transfer controller 10) of the plug A coupling side. Then, the transfer controller instructs the feed switch circuit 70 to start the VBUS power feed.

More particularly, the transceiver 52, the SIE 54 and others in the transfer controller 50 receive the switch request packet and send the switch consent packet by, for example, the control transfer of USB. Then, when it agrees to the VBUS feed switch, the VBUS controller 58 activates a switch signal SSB (or SSBL) and turns on a switch element SB (or SSBL). This starts the VBUS power feed (the normal voltage feed or the low voltage feed) by the plug B coupling side. These series of negotiation processes are performed under the control of the negotiation unit 62.

As described above, in this exemplary embodiment, the VBUS power feed is successfully switched from the plug A coupling side to the plug B coupling side. Consequently, for example, the printer 310 that is coupled to the plug B can feed the VBUS power to the digital camera 300 that is coupled to the plug A as shown in FIG. 2C. Therefore, when the printer 310 has the AC power source, the VBUS power can be fed to the digital camera 300 by using this AC power source. Consequently, the battery drain of the digital camera 300 can be reduced. In addition, in this exemplary embodiment, such VBUS power feed switch is conducted through the negotiation process using the packet transfer. Therefore, the VBUS power feed switch is reliably and safely conducted because the VBUS feed is switched as electronic equipment confirms each other whether the other electronic equipment has the AC power source or not. Furthermore, there is an advantage that the VBUS power feed switch can be realized by only mounting firmware or application program for the switch on the data transfer control device.

Furthermore, the following advantage can be obtained by combining such VBUS feed switch technique and the above-described VBUS feed voltage switchover technique. For example, if both the plug A coupling side and the plug B coupling side work on battery, firstly, the plug A coupling side feeds the VBUS low voltage to the plug B coupling side in the manner described in FIG. 2B. Then, if the battery of the plug A coupling side is running low, the VBUS power feed is switched from the plug A coupling side to the plug B coupling side in the manner described in FIG. 2C. And the plug B coupling side feeds the VBUS low voltage to the plug A coupling side in the manner described in FIG. 2B. In this way, the VBUS feed is possible until the both batteries die and the both batteries can be efficiently used to feed the VBUS power. The VBUS power feed switch request and the switch consent may be told by other devices (for example, change in the voltage level of the data line) than the packet transfer.

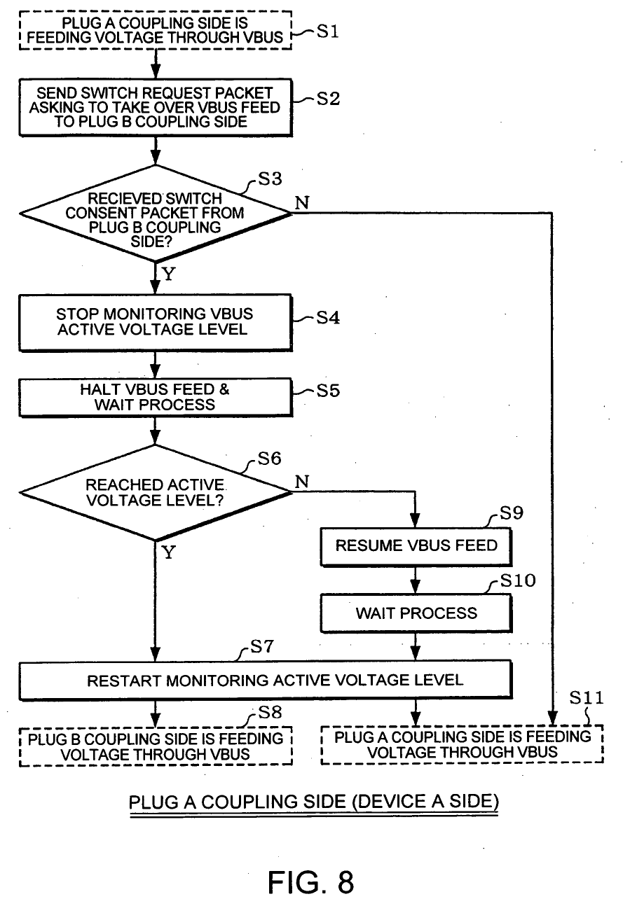

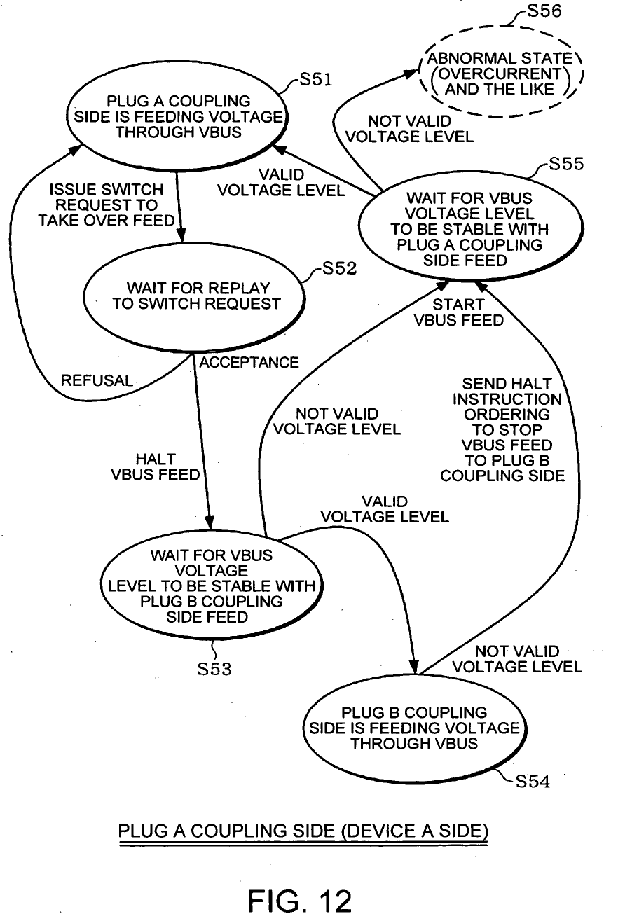

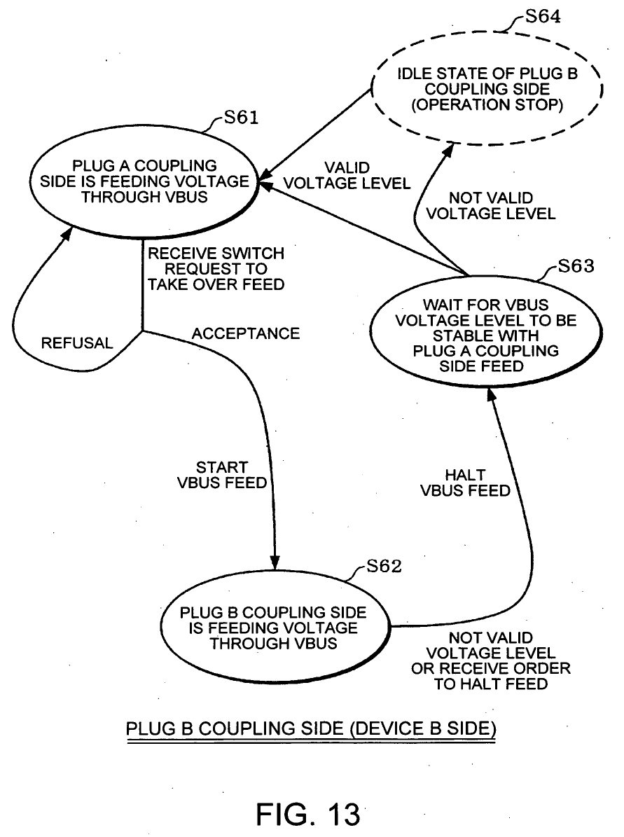

Next, the actions of the data transfer control device of the exemplary embodiment when the VBUS power feed is switched are described in detail with reference to flowcharts in FIGS. 8 through 11 and state transition diagrams in FIG. 12 and FIG. 13.

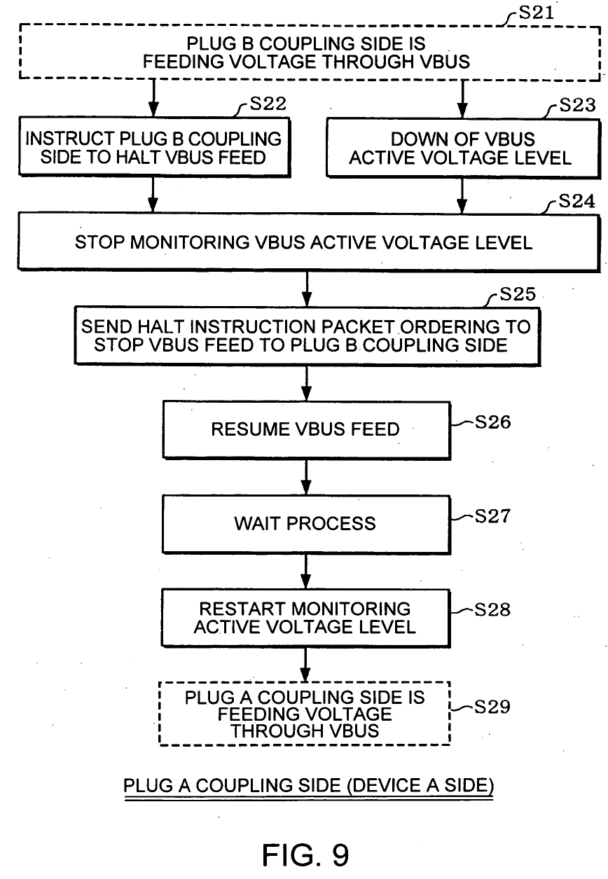

FIGS. 8 and 9 show action flows of the data transfer control device of the plug A coupling side. Firstly, the switch request packet to switch the VBUS power feed is sent to the plug B coupling side (step: S2) while the plug A coupling side is feeding power through the VBUS (step: S1). When the plug A coupling side receives the switch consent packet to switch the VBUS power feed from the plug B coupling side (step: S3), monitor of the VBUS active voltage level is stopped (step: S4). In other words, the plug A coupling side instructs the normal voltage monitoring circuit 40 (or the low voltage monitoring circuit 42) to stop monitoring the VBUS voltage level.

Subsequently, the VBUS power feed is halted and the process is waited (step: S5) in order to wait for the VBUS voltage level to be stabilized. In other words, the feed switch circuit 30 is instructed to stop the VBUS power feed (turns off the switch element SA or SAL). Also, in order to wait the VBUS voltage level to be stabilized, the process is waited for a predetermined period. When the predetermined period passed and the VBUS voltage level is reached the active voltage level (step: S6), the monitor of the active voltage level is resumed (step: S7). In other words, the normal voltage monitoring circuit 40 (or the low voltage monitoring circuit 42) is instructed to resume monitoring the VBUS voltage level. In this way, the plug B coupling side gets to feed power through the VBUS (step: S8).

On the other hand, if the VBUS voltage level is not reached the active voltage level (step: S6), the VBUS power feed by the plug A coupling side is resumed (step: S9). In other words, the feed switch circuit 30 is instructed to resume the VBUS power feed (turns on the switch element SA or SAL). Then, the process is waited for the predetermined period (step: S10) in order to wait the VBUS voltage level to be stabilized. After that, the monitor of the active voltage level is resumed (step: S7). In this way, the plug A coupling side gets to feed power through the VBUS (step: S11).

As shown in FIG. 8, in this exemplary embodiment, the monitor of the VBUS voltage level is stopped before the VBUS power feed is halted (step: S4 and S5). And the wait process is conducted after the VBUS power feed is halted, and then the monitor of the VBUS voltage level is resumed (step: S5, S6 and S7).

If the plug A coupling side halts the VBUS power feed in order to switch the VBUS feed, the VBUS voltage level becomes unstable until the plug B coupling side properly starts the VBUS power feed. If the monitor of the VBUS voltage level is normally conducted at this time, the abnormal state of the VBUS voltage level would be erroneously detected.

Considering this, in this exemplary embodiment, the monitor of the VBUS voltage level is stopped before the VBUS power feed is halted. This can prevent or reduce the abnormal state of the VBUS voltage level from being erroneously detected. Furthermore, the monitor of the VBUS voltage level is resumed after the wait process and it can help properly monitor whether the plug B coupling side feeds the VBUS power appropriately or not. In this way, this exemplary embodiment realizes the switch of the VBUS power feed as well as it meets requirements of the USB standard on the monitor of the VBUS voltage level.

Next, an exemplary action flow in the FIG. 9 is explained. Firstly, the plug B coupling side is feeding power through the VBUS (step: S21). When the upper layer (for example, application layer and the like) instructs to stop the VBUS power feed by the plug B coupling side (step: S22) or the VBUS active voltage level goes down (step: S23), the monitor of the VBUS active voltage level is stopped (step: S24). In other words, the normal voltage monitoring circuit 40 (or the low voltage monitoring circuit 42) is instructed to stop monitoring the VBUS voltage level.

Then, a halt instruction packet ordering to stop the VBUS power feed is sent to the plug B coupling side (step: S25), and the plug A coupling side resumes the VBUS power feed (step: S26). In other words, the VBUS feed halt instruction is issued and the feed switch circuit 30 is instructed to resume the VBUS power feed by the plug A coupling side. Then, the process is waited (step: S27) in order to wait the VBUS voltage level to be stabilized. After that, the monitor of the active voltage level is resumed (step: S28). In other words, the normal voltage monitoring circuit 40 (or the low voltage monitoring circuit 42) is instructed to resume monitoring the VBUS voltage level. In this way, the plug A coupling side gets to feed power through the VBUS (step: S29).

In this exemplary embodiment, when the halt of the VBUS power feed by the plug B coupling side is instructed by the upper layer or the VBUS voltage level becomes lower than the active voltage level, the halt instruction packet ordering to stop the VBUS power feed is sent to the plug B coupling side (step: S22, S23 and S25). Then, the plug A coupling side resumes the VBUS power feed (step: S26). In this way, when the application program or the firmware indicates to halt the plug B coupling side feed or the VBUS voltage level becomes an abnormal state, it can be possible to stop the VBUS power feed by the plug B coupling side and get back to the VBUS power feed by the plug A coupling side. Therefore, when an abnormal state happens in the plug B coupling side VBUS feed, such abnormal state can be prevented by the plug A coupling side's feeding the VBUS power. Moreover, for example, when the plug B coupling side battery runs out of power because of the VBUS feed, it is possible to stop the VBUS power feed by the plug B coupling side with an instruction from the application program of the plug A coupling side, and then the VBUS feed can be conducted by the battery of the plug A coupling side.

In this exemplary embodiment, the monitor of the VBUS voltage level is stopped before the VBUS power feed is resumed (step: S24 and S26). Subsequently, the wait process is conducted after the resumption of the VBUS power feed and then the monitor of the VBUS voltage level is resumed (step: S26, S27 and S28).

As described above, the monitor of the VBUS voltage level is stopped before the VBUS power feed is resumed. This can prevent or reduce the abnormal state of the VBUS voltage level from being erroneously detected. In addition, the monitor of the VBUS voltage level is resumed after the wait process. This can help properly monitor whether the plug A coupling side feeds the VBUS power appropriately or not.

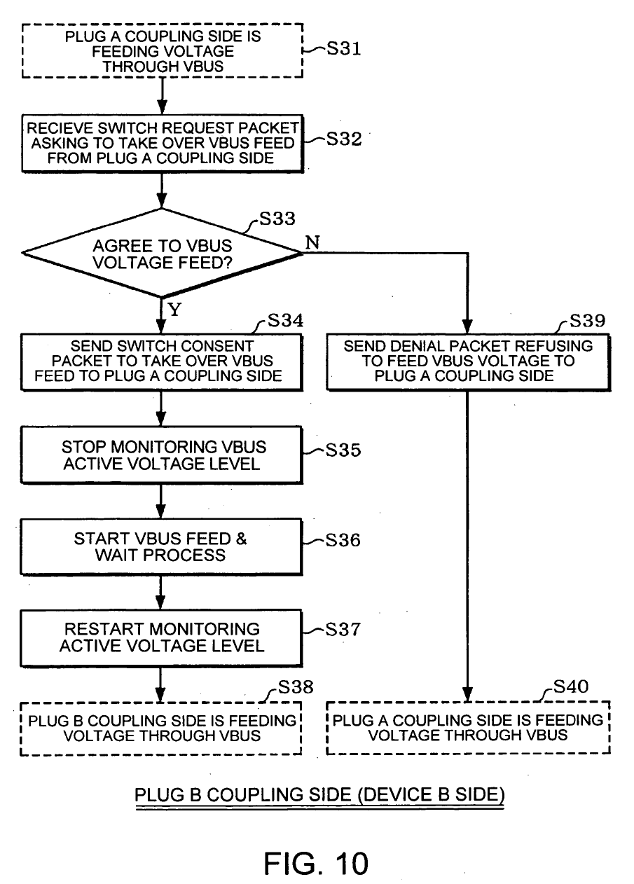

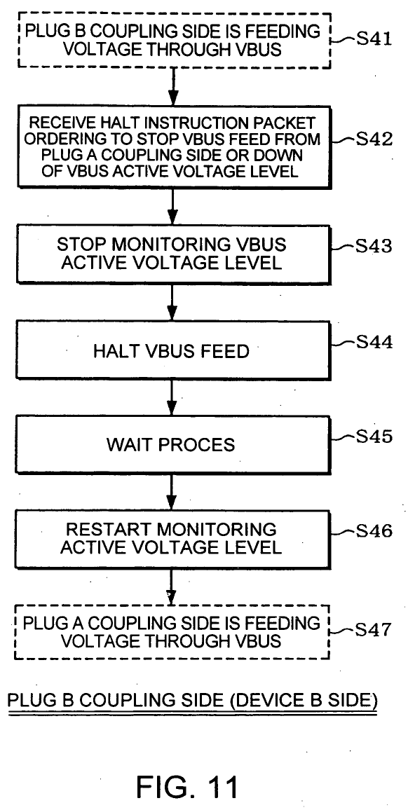

FIGS. 10 and 11 show exemplary action flows of the data transfer control device of the plug B coupling side. Firstly, the plug B coupling side receives the switch request packet to switch the VBUS power feed from the plug A coupling side (step: S32) while the plug A coupling side is feeding power through the VBUS (step: S31). When the plug B coupling side agrees to the VBUS power feed (step: S33), the switch consent packet is sent to the plug A coupling side (step: S34).

Then, the monitor of the VBUS active voltage level is stopped (step: S35). In other words, the normal voltage monitoring circuit 80 (or the low voltage monitoring circuit 82) is instructed to stop monitoring the VBUS voltage level. Subsequently, the VBUS power feed by the plug B coupling side is started and the wait process is conducted (step: S36) in order to wait the VBUS voltage level to be stabilized. In other words, the feed switch circuit 70 is instructed to start the VBUS power feed (turns on the switch element SB). Also, in order to wait the VBUS voltage level to be stabilized, the process is waited for a predetermined period. When the predetermined period passed, the monitor of the active voltage level is resumed (step: S37). In other words, the normal voltage monitoring circuit 80 (or the low voltage monitoring circuit 82) is instructed to resume monitoring the VBUS voltage level. In this way, the plug B coupling side gets to feed power through the VBUS (step: S38).

On the other hand, when the plug B side does not agree to switch the VBUS power feed (step: S33), the switch denial packet telling not to switch the VBUS power feed is sent to the plug A coupling side (step: S39). With this action, the plug A coupling side keeps feeding power through the VBUS (step: S40).

As shown in FIG. 10, in this exemplary embodiment, the monitor of the VBUS voltage level is stopped before the VBUS power feed is resumed (step: S35 and S36). Subsequently, the wait process is conducted after the resumption of the VBUS power feed and then the monitor of the VBUS voltage level is resumed (step: S36 and S37).

As described above, the monitor of the VBUS voltage level is stopped before the VBUS power feed is resumed. This can prevent the abnormal state of the VBUS voltage level from being erroneously detected. In addition, the monitor of the VBUS voltage level is resumed after the wait process. This can help properly monitor whether the plug B coupling side feeds the VBUS power appropriately or not.

Next, an action flow in the FIG. 11 is explained. Firstly, the plug B coupling side is feeding power through the VBUS (step: S41). When the plug B coupling side receives the halt instruction packet ordering to stop the VBUS power feed from the plug A coupling side or the VBUS active voltage level goes down (step: S42), the monitor of the VBUS active voltage level is stopped (step: S43). In other words, the normal voltage monitoring circuit 80 (or the low voltage monitoring circuit 82) is instructed to stop monitoring the VBUS voltage level. Then, the VBUS power feed by the plug B coupling side is halted (step: S44). In other words, the feed switch circuit 70 is instructed to halt the VBUS power feed.

Subsequently, in order to wait the VBUS voltage level to be stabilized, the process is waited (step: S45). After that, the monitor of the VBUS active voltage level is resumed (step: S46). In other words, the normal voltage monitoring circuit 80 (or the low voltage monitoring circuit 82) is instructed to resume monitoring the VBUS voltage level. In this way, the plug A coupling side gets to feed power through the VBUS (step: S47).

According to the exemplary embodiment, when the plug B coupling side receives the switch request packet to switch the VBUS power feed from the plug A coupling side or the VBUS active voltage level goes down, the VBUS power feed is halted (step: S42 and S44).

In this way, when the application program or the firmware of the plug A coupling side indicates to halt the plug B coupling side feed or the VBUS voltage level becomes an abnormal state, it is possible to stop the VBUS power feed by the plug B coupling side. Therefore, when an abnormal state happens in the plug B coupling side VBUS feed, such abnormal state can be reduced or prevented.

In this exemplary embodiment, the monitor of the VBUS voltage level is stopped before the VBUS power feed is halted (step: S43 and S44). Subsequently, the wait process is conducted after the VBUS power feed is halted and then the monitor of the VBUS voltage level is resumed (step: S44, S45 and S46).

As described above, the monitor of the VBUS voltage level is stopped before the VBUS power feed is halted. This can prevent or reduce the abnormal state of the VBUS voltage level from being erroneously detected. In addition, the monitor of the VBUS voltage level is resumed after the wait process. This can help properly monitor whether the plug A coupling side feeds the VBUS power appropriately or not.

A state transition diagram showing an action of the plug A coupling side is shown in FIG. 12. Firstly, the plug A coupling side is feeding power through the VBUS (state: S51). When a switch request to take over the feed is issued, the plug A coupling side waits for a reply to the switch request from the plug B coupling side (state: S52). Then, if a refusal answer is received, the plug A coupling side keeps feeding power through the VBUS (state: S51). On the other hand, if an acceptance answer is received, the VBUS power feed by the plug A coupling side is halted and it is waited that the VBUS voltage level becomes stable with the plug B coupling side feed (state: S53). Then, if the VBUS voltage level becomes valid, the plug B coupling side gets to feed power through the VBUS (state: S54).

If the VBUS voltage level is not valid at the state S53 or S54, the plug A coupling side starts to feed the VBUS power and it is waited that the VBUS voltage level becomes stable with the plug A coupling side feed (state: S55). Then, if the VBUS voltage level is still not valid, it is judged as an abnormal state (state: S56). On the other hand, if the VBUS voltage level becomes valid, the plug A coupling side gets to feed power through the VBUS (state: S51).

A state transition diagram showing an action of the plug B coupling side is shown in FIG. 13. Firstly, the plug A coupling side is feeding power through the VBUS (state: S61). When the plug B coupling side receives the switch request to take over the feed from the plug A coupling side and accepts it, the plug B coupling side starts the VBUS power feed (state: S62). On the other hand, when the plug B coupling side refuses the switch request to take over the feed, the plug A coupling side keeps feeding power through the VBUS (state: S61).

If the plug B coupling side receives the halt instruction packet ordering to stop the VBUS power feed from the plug A coupling side or the VBUS active voltage level goes down while the plug B coupling side is feeding power through the VBUS (step: S62), it stops to feed the VBUS power and waits for the VBUS voltage level to become stable with the plug A coupling side feed (state: S63). Then if the VBUS voltage level is valid, the plug A coupling side gets to feed power through the VBUS (state: S61). On the other hand, if the VBUS voltage level is not valid, the plug B coupling side becomes idle (stops the operation) (state: S64).

7. Use of Control Transfer

Transmission of the switchover request packet to switch over the VBUS feed voltage, the switchover consent packet, the switch request packet to switch the VBUS power feed and the switch consent packet can be performed by using a control transfer of USB.

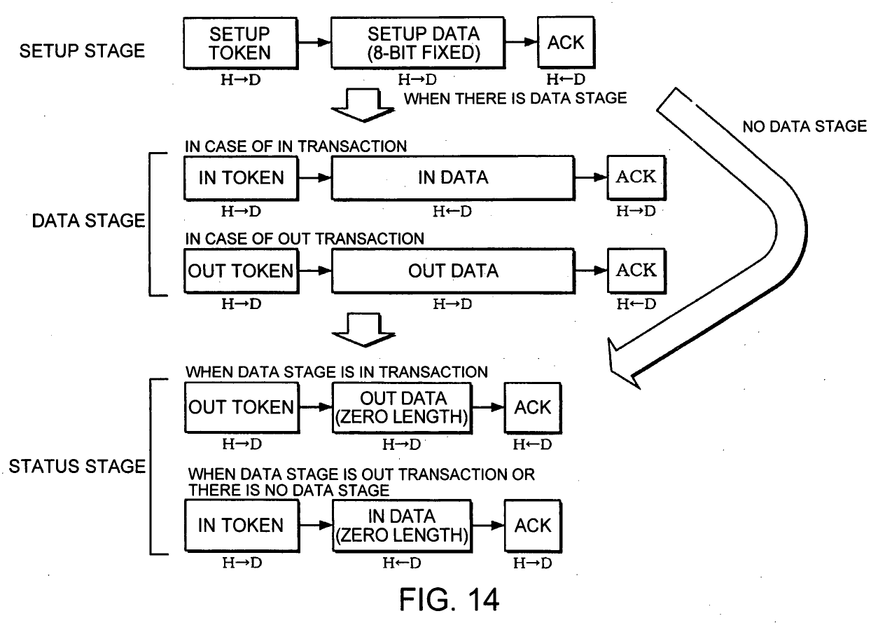

The control transfer of USB is schematically shown in FIG. 14. In FIG. 14, “H→D” refers transferring a packet to an USB device (target or peripheral) from a host, and “H←D” refers transferring a packet to the host from the USB device. In USB, normally, the plug A coupling side is the host and the plug B coupling side is the USB device. In OTG, roles of the host and the USB device (peripheral) can be switched with Host Negotiation Protocol (HNP). It can mean that the device A to which the plug A is coupled can be the USB device and the device B to which the plug B is coupled can be the host.

The control transfer is a transfer mode for control which is performed between the host and the USB device through a control end point (an end point whose end point number is 0). The control transfer has a setup stage, a data stage and a status stage. In the setup stage, the host sends a device request to the USB device. In the data stage, a data is transferred in a direction which is specified by the device request. And in the status stage, whether the data transfer is successfully finished or not is determined.

In the setup stage of the control transfer, the host (H) generates a setup token packet and sends it to the USB device (D). Then, the host sends a setup data packet that includes the device request to the USB device. The USB device receives the setup data packet and sends a handshake packet of acknowledgement (ACK) to the host. When the host receives the ACK handshake packet from the USB device, it closes the setup stage.

When the setup stage is closed, the process moves into the data stage. If the device request does not have the data stage, the data stage is skipped and the process moves into the status stage.

In the device request in which a transfer direction in the data stage is “IN”, the host generates an IN transaction at the data stage, and the data is transferred to the host from the USB device. On the other hand, in the device request in which the transfer direction in the data stage is “OUT”, the host generates an OUT transaction at the data stage, and the data is transferred to the USB device from the host. Then, when the data stage is closed, the process moves into the status stage.

In the status stage, when the data stage was the IN transaction, the host issues an OUT token and sends an OUT data packet that is zero length to the USB device. On the other hand, when the data stage was the OUT transaction, the host issues an IN token and sends an IN data packet that is zero length to the USB device.

For example, when the switchover request packet and the switch request packet are sent, the host, which is the plug A coupling side, sends the OUT data that includes the data notifying the switchover request and the switch request to the USB device which is the plug B coupling side. In other words, the switchover request packet and the switch request packet are sent as an OUT token packet. On the other hand, when the switchover consent packet and the switch consent packet are sent, the USB device, which is the plug B coupling side, sends the IN data that includes the data notifying the switchover consent and the switch consent to the host which is the plug A coupling side. In other words, the switchover consent packet and the switch consent packet are sent as an IN data packet.

When roles of the host and the peripheral (USB device) are switched by OTG and the device A to which the plug A is coupled becomes the peripheral and the device B to which the plug B is coupled becomes the host, the switchover request packet and the switch request packet are sent as the IN data packet and the switchover consent packet and the switch consent packet are sent as the OUT data packet.

When the device A (plug A coupling side) becomes the peripheral and the device B (plug B coupling side) becomes the host by HNP of OTG, only the device B, which is the host, can issue the tokens. The negotiation technique of the exemplary embodiment is based on the premise that the device A starts the VBUS negotiation. Therefore, the VBUS negotiation should be started when the device A is the host.

In this case, in the OTG standard, it is allowed that the device A works as the host anytime. In other words, even when the device A becomes the peripheral by HNP, the device A can get a host operation right (right to operate as the host) back at anytime. Therefore, when the device A works as the peripheral by HNP, the device A reclaims the host operation right with HNP, then the VBUS negotiation (VBUS feed switch negotiation or VBUS low voltage feed negotiation) is conducted in the above-described manner. After that, the device A moves back to the peripheral mode by HNP.

As described above, when the switchover request packet, the switch request packet, the switchover consent packet and the switch consent packet are sent by using the control transfer, there is an advantage that the VBUS feed voltage switchover and the VBUS power feed switch can be reliably and safely conducted.

8. Electronic Equipment

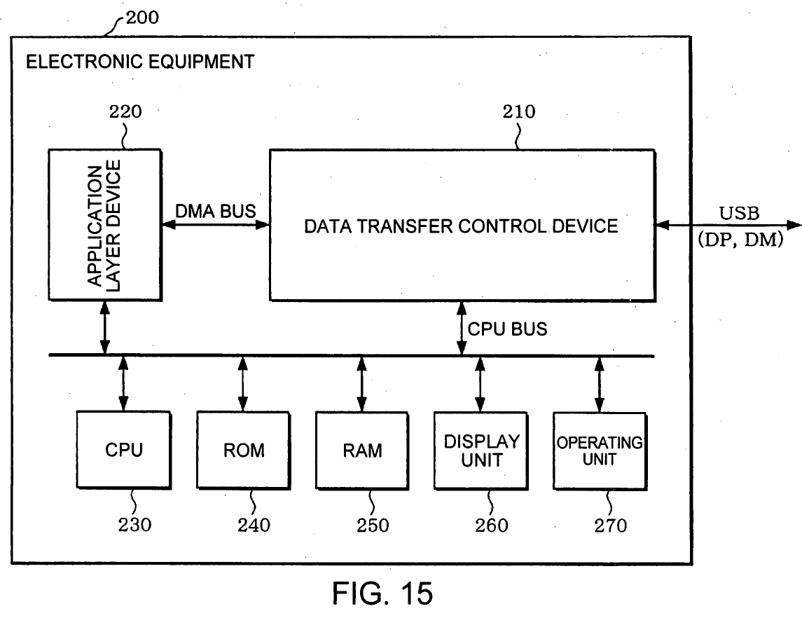

An example of the electronic equipment that includes the data transfer control device of the exemplary embodiment is shown in FIG. 15. Exemplary electronic equipment 200 can include the above-described data transfer control device 210, an application layer device 220 which is made of application specific integrated circuits (ASIC). The electronic equipment 200 also includes a CPU 230, a ROM 240, a RAM 250, a display unit 260 and an operating unit 270. A part of these function blocks may be omitted.

Here, the application layer device 220 is, for example, a hard disk drive, an optical disk drive, a device that controls the printer and a device that includes a Moving Picture Experts Group (MPEG) encoder, a MPEG decoder and the like. The CPU 230 controls the data transfer control device 210 and the whole of the electronic equipment. The ROM 240 stores a control program and various data. The RAM 250 works as the CPU 230, a work region of the data transfer control device and a data storing region. The display unit displays various information to the user. The operating unit 270 is for the user to operate the electronic equipment.

Though a DMA bus and a CPU bus are separated in FIG. 15, they may be put together. Moreover, a CPU that controls the data transfer control device 210 and a CPU that controls the electronic equipment may be provided separately. As electronic equipment to which the present invention can be applied, the optical disc drive (CD-ROM, DVD), a magnetic optical disc drive (MO), the hard disk drive, TV, a TV tuner, a video tape recorder (VTR), a video camera, an audio instrument, telephone equipment, a projector, a personal computer, an electronic databook, a word processor and the like can be named.

It should be understood that the present invention is not limited to the above-described embodiment, but applied to various kinds of modifications within the scope and spirit of the invention.

For example, the structure of the data transfer control device of the present invention is not limited to the structure described in FIG. 3 and the like but various kinds of modifications are possible. Also, the actions of the data transfer control device of the present invention are not limited to the actions described in FIGS. 4 through 13 and the like.

Words and terms that are used in the specification and the figures as broad terms or equivalent terms (the plug A coupling side, the plug B coupling side and the like) can be replaced with broad terms or equivalent terms (the device A side, the device B side and the like) in other description of the specification and the figures.

Further, while this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. A data transfer control device for a data transfer through a Universal Serial Bus (USB), comprising:
a transfer controller that controls the data transfer; and
a feed switch circuit that controls a switch of a power supply to a VBUS line of the USB,
when the data transfer control device is a data transfer control device coupled to a plug A of the USB, the transfer controller sends a switchover request packet to switch over a VBUS feed voltage from a normal voltage feed to a low voltage feed to a data transfer controller coupled to a plug B, and
when the plug A coupling side data transfer control device receives a switchover consent packet from the plug B coupling side data transfer control device, the transfer controller instructs the feed switch circuit to switch over from the normal voltage feed to the low voltage feed.

2. The data transfer control device according to claim 1, further comprising:
a normal voltage monitoring circuit that monitors a VBUS voltage level at a time of the VBUS normal voltage feed; and
a low voltage monitoring circuit that monitors the VBUS voltage level at a time of the VBUS low voltage feed, when the transfer controller instructs the feed switch circuit to switch over from the normal voltage feed to the low voltage feed, the transfer controller instructs the normal voltage monitoring circuit to stop monitoring the VBUS voltage level and instructs the low voltage monitoring circuit to start monitoring the VBUS voltage level.

3. The data transfer control device according to claim 1,
when a switchover from the low voltage feed to the normal voltage feed is instructed by an upper layer, the transfer controller sends a switchover notification packet to switch over the VBUS feed voltage from the low voltage feed to the normal voltage feed to the plug B coupling side data transfer control device and instructs the feed switch circuit to switch over from the low voltage feed to the normal voltage feed.

4. The data transfer control device according to claim 3, further comprising:
a normal voltage monitoring circuit that monitors a VBUS voltage level at a time of the VBUS normal voltage feed; and
a low voltage monitoring circuit monitoring the VBUS voltage level at a time of the VBUS low voltage feed,
a wait process being conducted after the transfer controller instructs the feed switch circuit to switch over from the low voltage feed to the normal voltage feed, and then the transfer controller instructs the normal voltage monitoring circuit to start monitoring the VBUS voltage level.

5. The data transfer control device according to claim 1,
when the data transfer control device is the data transfer control device coupled to the plug A of the USB, the transfer controller sends a switch request packet to switch a VBUS power feed to the data transfer controller coupled to the plug B, and
when the plug A coupling side data transfer control device receives a switch consent packet to switch the VBUS power feed from the plug B coupling side data transfer control device, the transfer controller instructs the feed switch circuit to halt the VBUS power feed.

6. The data transfer control device according to claim 1, the transfer controller sending the switchover request packet by control transfer of the USB.

7. A data transfer control device for a data transfer through a Universal Serial Bus (USB), comprising:
a transfer controller that controls the data transfer; and
a feed switch circuit that controls a switch of a power supply to a VBUS line of the USB,
when the data transfer control device is a data transfer control device coupled to a plug B of the USB, the transfer controller receives a switchover request packet to switch over a VBUS feed voltage from a normal voltage feed to a low voltage feed from a data transfer controller coupled to a plug A, and
when the plug B coupling side data transfer control device agrees to the switchover, the transfer controller sends a switchover consent packet to switch over from the normal voltage feed to the low voltage feed to the plug A coupling side data transfer control device.

8. The data transfer control device according to claim 7, further comprising:
a normal voltage monitoring circuit that monitors a VBUS voltage level at the time of the VBUS normal voltage feed; and
a low voltage monitoring circuit that monitors the VBUS voltage level at a time of the VBUS low voltage feed,
when the transfer controller sends the switchover consent packet to switch over from the normal voltage feed to the low voltage feed to the plug A coupling side data transfer control device, the transfer controller instructs the normal voltage monitoring circuit to stop monitoring the VBUS voltage level and instructs the low voltage monitoring circuit to start monitoring the VBUS voltage level.

9. The data transfer control device according to claim 7, further comprising:
a normal voltage monitoring circuit that monitors a VBUS voltage level at the time of the VBUS normal voltage feed; and
a low voltage monitoring circuit that monitors the VBUS voltage level at a time of the VBUS low voltage feed,
when the transfer controller receives the switchover consent packet to switch over the VBUS feed voltage from the low voltage feed to the normal voltage feed from the plug A coupling side data transfer control device, a wait process is conducted, and then the transfer controller instructs the normal voltage monitoring circuit to start monitoring the VBUS voltage level.

10. The data transfer control device according to claim 7,
when the data transfer control device is the data transfer control device coupled to the plug B of the USB, the transfer controller receives a switch request packet to switch a VBUS power feed from the data transfer controller coupled to the plug A, and
when the plug B coupling side data transfer control device agrees to the switch, the transfer controller sends a switch consent packet to switch the VBUS power feed to the plug A coupling side data transfer control device and instructs the feed switch circuit to start the VBUS power feed.

11. The data transfer control device according to claim 7,
the transfer controller sending the switchover consent packet by control transfer of the USB.

12. Electronic equipment, comprising:
the data transfer control device according to claim 1; and
a central processing unit (CPU) that controls the data transfer control device.

13. Electronic equipment, comprising:
the data transfer control device according to claim 7; and
a central processing unit (CPU) that controls the data transfer control device.
